(19) United States
(12) Patent Application Publication
(10) Pub. No.: US 2017/0223136 A1
(43) Pub. Date: Aug. 3, 2017

(54) Any Web Page Reporting and Capture

(71) Applicant: AppDynamics, Inc., San Francisco, CA (US)

(72) Inventors: Ganesh Ghosh, San Francisco, CA (US); Jonathan Newcomb Swirsky Whitney, Belmont, CA (US); Tao Wang, Daly City, CA (US); Ryan O'Connell, San Francisco, CA (US)

(21) Appl. No.: 15/011,134

(22) Filed: Jan. 29, 2016

(51) Int. Cl. H04L 29/08; H04L 12/26; G06F 17/22

(52) U.S. Cl. CPC H04L 67/32; G06F 17/2247; G06F 17/2235; H04L 67/22; H04L 43/08; H04L 43/04; G06F 3/0482

(57) ABSTRACT

A mechanism is disclosed for securely capturing all or part of a page related to a registered user's point of view. The capture may be performed according to a schedule, immediately or in response to a trigger event, and may capture selected content as requested by a requestor. Capturing content may involve having a requester login with access credentials, provide scheduling information regarding when the capture should occur, and an indication of which recipients should receive the capture data. The content captured may be selected by the requester and captured from the requester's perceived point of view at the scheduled time.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

In systems that monitor application programs, applications and webpages often behave differently or show different data for different users. Any experience reports, status reports, and other such documents are often accomplished through the point of view of an administrator, developer or a test user account. This leaves any in-house reporting agnostic to the point of view of any given user and the particular user's details, status, and particular experience of the system.

### SUMMARY

The present technology, roughly described, provides a mechanism to securely capture all or part of a page related to a registered user's point of view. The capture may be performed according to a schedule, immediately or in response to a trigger event, and may capture selected content as requested by a requester. Capturing content may involve having a requester login with access credentials, provide scheduling information regarding when the capture should occur, and an indication of which recipients should receive the capture data. The content captured may be selected by the requester and captured from the requester's perceived point of view at the scheduled time.

Some implementations may include a method for securely scheduling capture of interface data. A request may be received by a server to capture interface content at a particular schedule for an identified access level. At a time specified within the scheduled request, selected content associated with the interface may be accessed by the server. A document populated by the server with the accessed selected content. The document with the selected content may be provided by the server along with an access token generated based on the identified access level.

Some implementations may include a system for securely scheduling capture of interface data. The system may include a plurality of machines, with each machine including a processor and memory, and one or more modules stored in memory and executable by the processor. When executed, the modules may receive a request to capture interface content at a particular schedule for an identified access level, at a time specified within the scheduled request, access selected content associated with the interface, populate a document with the accessed selected content, and provide the document with the selected content along with an access token generated based on the identified access level.

### BRIEF DESCRIPTION OF THE DRAWINGS

FIG. 1 is a block diagram of an exemplary system for monitoring a distributed transaction.

FIG. 2 is a block diagram of an exemplary system for capturing content rendered in an interface.

FIG. 3 is an exemplary method for capturing a rendered rebel interface.

FIG. 4 is an exemplary method for receiving a request to capture a user interface.

FIG. 5 is an exemplary method for processing a request to construct the URL by a controller.

FIG. 6 is an exemplary method for extracting content and generating a report by a reporting server.

FIG. 7 is an exemplary interface from which content should be captured at a scheduled time.

FIG. 8 is an exemplary interface of content which was captured from a rendered rebel interface.

FIG. 9 is an exemplary system for implementing the present technology

### DETAILED DESCRIPTION

The present technology, roughly described, provides a mechanism to securely capture all or part of a page related to a registered user's point of view. The capture may be performed according to a schedule, immediately or in response to a trigger event, and may capture selected content as requested by a requester. Capturing content may involve having a requester login with access credentials, provide scheduling information regarding when the capture should occur, and an indication of which recipients should receive the capture data. The content captured may be selected by the requester and captured from the requester's perceived point of view at the scheduled time.

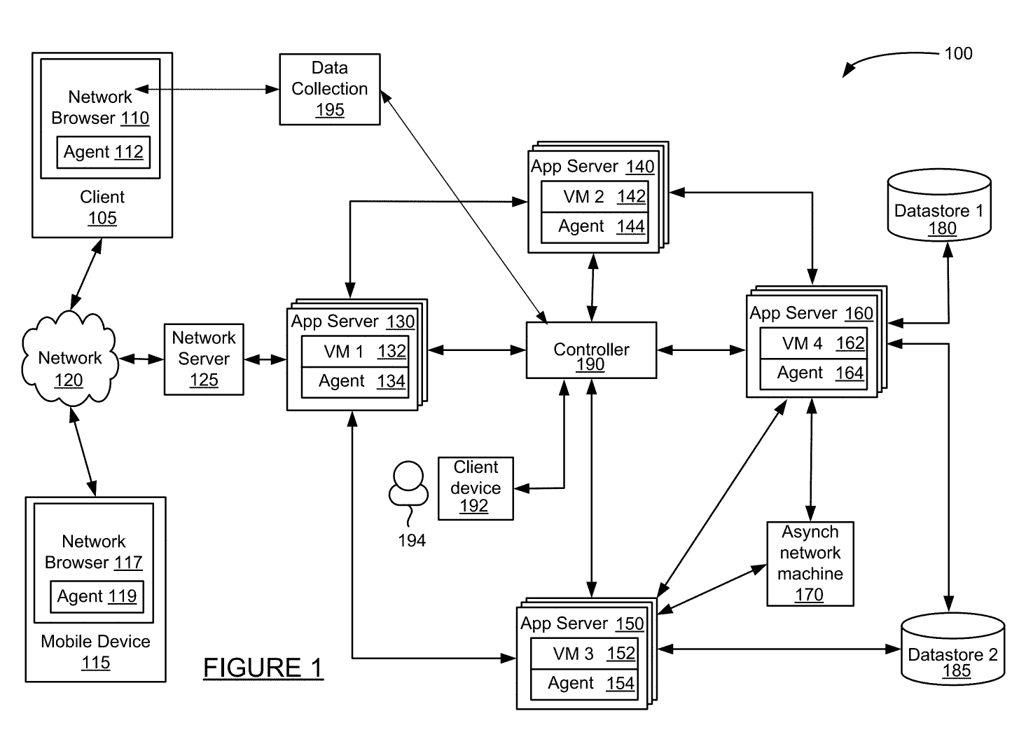

FIG. 1 is a block diagram of an exemplary system for monitoring a distributed business transaction. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Mobile device may also include client applications and other code that may be monitored by agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130 or one or more separate machines. When network 120 is the Internet, network server 125 may be implemented as a web server.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .Net, and Node.JS, be implemented as a Java virtual machine, or include some other host type. Application server 130 may also include one or more agents 134 (i.e. “modules”), including a language agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, servers 130, 140, 150, and 160 may each include Java code, .Net code, PHP code, Ruby code, C code, C++ or other binary code to implement applications and process requests received from a remote source. References to a virtual machine with respect to an application server are intended to be for exemplary purposes only.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .Net, or C program), machine resources, network layer data, and communicate with byte instrumented code on application server 130 and one or more applications on application server 130.

Each of agents 134, 144, 154 and 164 may include one or more agents, such as a language agents, machine agents, and network agents. A language agent may be a type of agent that is suitable to run on a particular host. Examples of language agents include a JAVA agent, .Net agent, PHP agent, and other agents. The machine agent may collect data from a particular machine on which it is installed. A network agent may capture network information, such as data collected from a socket.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (e.g., memory, processor, and so on). A tier of nodes may include a plurality of nodes which may process a similar business transaction, may be located on the same server, may be associated with each other in some other way, or may not be associated with each other.

A language agent may be an agent suitable to instrument or modify, collect data from, and reside on a host. The host may be a Java, PHP, .Net, Node.JS, or other type of platform. Language agent 220 may collect flow data as well as data associated with the execution of a particular application. The language agent may instrument the lowest level of the application to gather the flow data. The flow data may indicate which tier is communicating which with which tier and on which port. In some instances, the flow data collected from the language agent includes a source IP, a source port, a destination IP, and a destination port. The language agent may report the application data and call chain data to a controller. The language agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent 230 is installed. The network agent 230 may collect data by intercepting and performing packet capture on packets coming in from a one or more sockets. The network agent may receive flow data from a language agent that is associated with applications to be monitored. For flows in the flow group data that match flow data provided by the language agent, the network agent rolls up the flow data to determine metrics such as TCP throughput, TCP loss, latency and bandwidth. The network agent may then reports the metrics, flow group data, and call chain data to a controller. The network agent may also make system calls at an application server to determine system information, such as for example a host status check, a network status check, socket status, and other information.

A machine agent may reside on the host and collect information regarding the machine which implements the host. A machine agent may collect and generate metrics from information such as processor usage, memory usage, and other hardware information.

Each of the language agent, network agent, and machine agent may report data to the controller. Controller 210 may be implemented as a remote server that communicates with agents located on one or more servers or machines. The controller may receive metrics, call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

Agent 134 may create a request identifier for a request received by server 130 (for example, a request received by a client 105 or 115 associated with a user or another source). The request identifier may be sent to client 105 or mobile device 115, whichever device sent the request. In embodiments, the request identifier may be created when a data is collected and analyzed for a particular business transaction. Additional information regarding collecting data for analysis is discussed in U.S. patent application Ser. No. 12/878,919, titled “Monitoring Distributed Web Application Transactions,” filed on Sep. 9, 2010, U.S. Pat. No. 8,938,533, titled “Automatic Capture of Diagnostic Data Based on Transaction Behavior Learning,” filed on Jul. 22, 2011, and U.S. patent application Ser. No. 13/365,171, titled “Automatic Capture of Detailed Analysis Information for Web Application Outliers with Very Low Overhead,” filed on Feb. 2, 2012, the disclosures of which are incorporated herein by reference.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to conFIGURE collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as a content page, e.g., a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

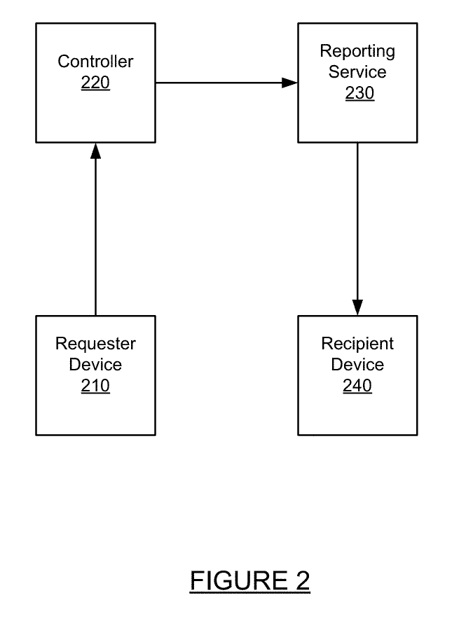

FIG. 2 is a block diagram of an exemplary system for capturing content rendered in an interface. The block diagram of FIG. 2 includes requester device 210, controller 220, reporting service 230, and recipient device 240. Requester device 210 may receive, render and display one or more interfaces provided by controller 220 for managing the monitoring the system of FIG. 1. In some instances, controller 220 of FIG. 2 may implement controller 190 of FIG. 1 and requester device 210 of FIG. 2 may implement client device 192 of FIG. 1.

Requester device 210 may request a capture event for an interface to controller 220. Controller 220 may receive and process a request, and ultimately construct a URL based on the request. The constructed URL may be provided to reporting service 230. From the constructed URL, reporting service 230 may extract selected portions of the URL, and provide those portions to recipient device 240. The content provided to a recipient device 240 may include a security token based on the access credentials of a requester that was logged in to a service provided by controller 220 and made the initial request.

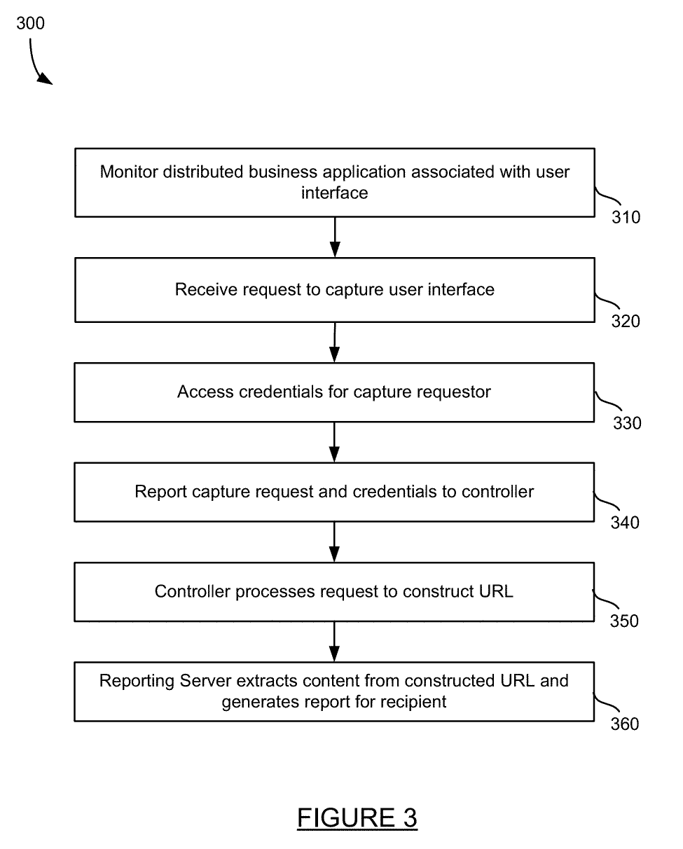

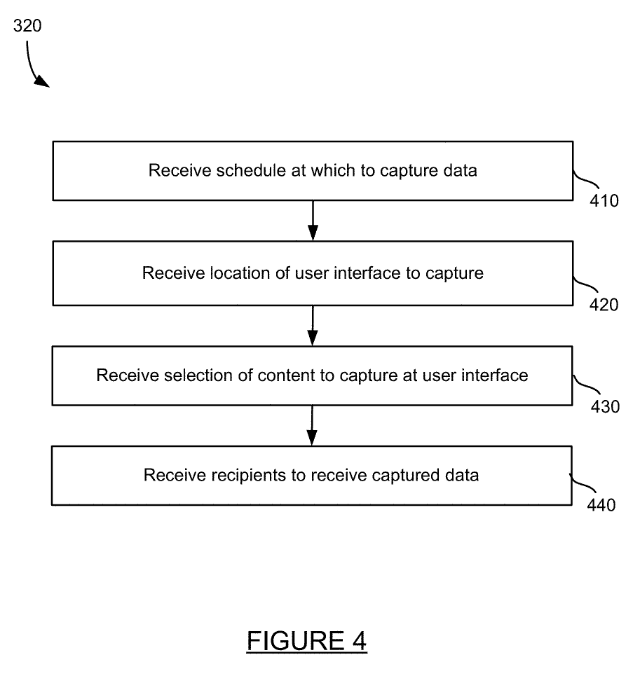

FIG. 3 is an exemplary method for capturing a interface. First, a distributed business transaction associated with an interface may be monitored at step 310. Monitoring the distributed business transaction may include monitoring applications, network flow, and user interface data provided by one or more applications on servers 130, 140, 150 and 160. A request may be received to capture a user interface at step 320. The request may be requester device 210. The request may include information regarding an interface to capture, scheduling information specifying when the capture should occur, and other information. A request to capture user interface is discussed in more detail below with respect to the method of FIG. 4.

Credentials for a capture request are accessed at step 330. In some instances, when the request to capture the user interface is received, a user will be logged into a service provided by controller 220 from requester device 210. The credentials may be automatically generated for the user that is logged into controller 220. The credentials will be stored along with the request to capture the user interface.

The request to capture a rendered page for the interface and credentials are reported to the controller at step 340. The credentials and capture request details are provided to controller 220 by requester device 210.

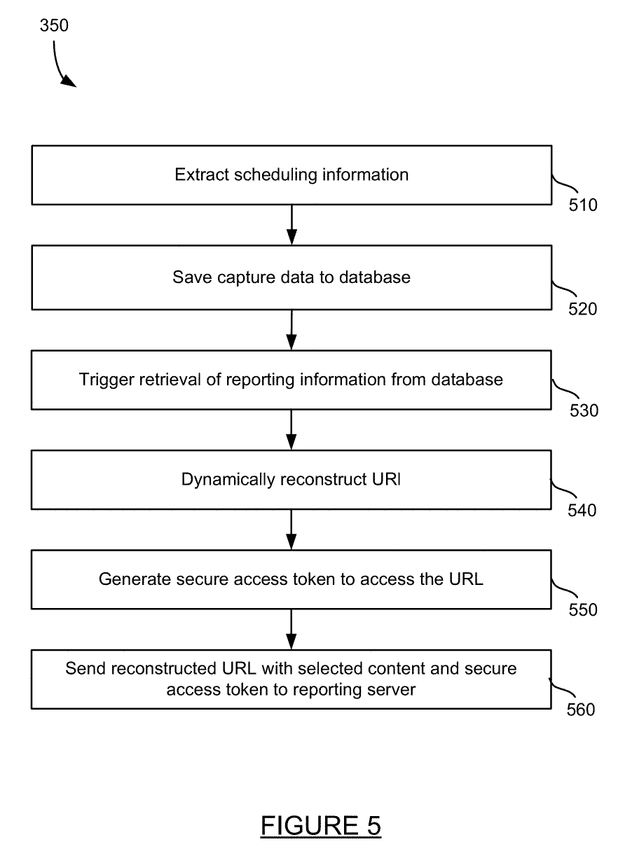

The controller may process a request to construct the interface at step 350. In some instances, constructing the interface may include constructing a URL at which the interface is located. Processing a request to construct a user interface by a controller is discussed in more detail with respect to the method of FIG. 5.

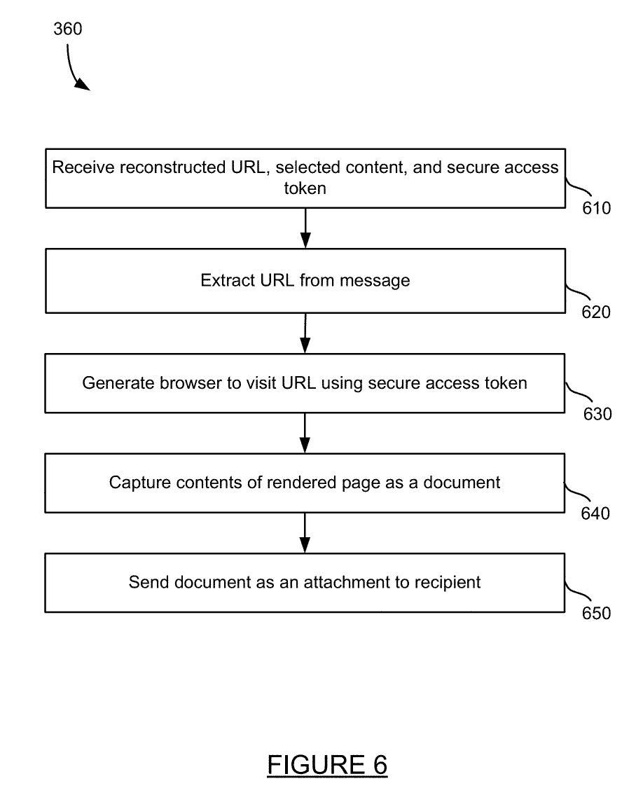

A reporting server may extract content from the constructed interface and generate a report for the recipient at step 360. The reporting server may extract information from the constructed interface provided by the controller to the reporting server. More detail for extracting content from constructed interface by reporting server and generating a report for recipient is discussed with respect to the method of FIG. 6.

FIG. 4 is an exemplary method for receiving a request to capture a user interface. The method of FIG. 4 provides more detail for step 320 of the method of FIG. 3. A schedule at which to capture data from the interface is received at step 410. The schedule may include a particular time and day at which the capture of the interface should occur. The scheduling data may also include a frequency, including whether the capture should only happen once or periodically. In some instances, the scheduling may be configured to occur upon an event, such as a low traffic load period of time, an anomaly associated with an application that provides the interface being captured, or some other event.

A location of the interface to capture is received at step 420. Location data may include a URL, or other address information. A selection of content to capture within the interface is received at step 430. In some instances, a requester may be presented with the interface through a web browser when configuring the capture. When presented with interface, the user may manually select portions within the interface that should be captured.

Recipients to receive the capture data are identified at step 440. The recipients may be identified by name, email address, account data, or some other identification.

FIG. 5 is an exemplary method for processing a request to construct the URL by a controller. The method of FIG. 5 provides more detail for step 350 of the method of FIG. 3. Scheduling information is extracted at step 510. Capture data is saved to a database at step 520. The capture data may include the scheduling information, the location of the content to retrieve, the content itself, the requester access credentials, and other data. Retrieval of reporting information is triggered at step 530. The reporting information may be retrieved from the database by a controller at the time of the scheduled content capture. In some instances, the capture may be initiated slightly before the scheduled capture, such as for example 2 minutes before the scheduled capture, to ensure that the content will be captured at the correct time.

The URL may be dynamically reconstructed at step 540. Dynamically reconstructing URL may include retrieving portions of the URL originally received from a requester and obtaining any missing portions by a controller. The controller may retrieve missing portions of the URL by accessing the partial or root URL and gathering any missing portions from the website associated with the URL.

A secure access token to access the URL is generated at step 550. The secure access token may be generated by the controller based on the credentials of the requester that initiated the capture. The secure access token may be a single use token that expires once a report is viewed. The secure access token may also be configured to expire within a short time period, such as two minutes, after content is retrieved by the controller. The reconstructed URL with the selected content and secure access token is reported to a reporting server at step 560

FIG. 6 is an exemplary method for extracting content and generating a report by a reporting server. The method of FIG. 6 provides more detail for step 360 of the method of FIG. 3. A reporting server receives the reconstructed URL, the selected content, and the secure access token at step 610. Content is then extracted from the reconstructed URL at step 620. A browser is generated to visit the URL using a secure access token at step 630. Contents of the rendered page are then captured and stored in a document by the reporting server at step 640. The document is then sent as an attachment to recipient at step 650.

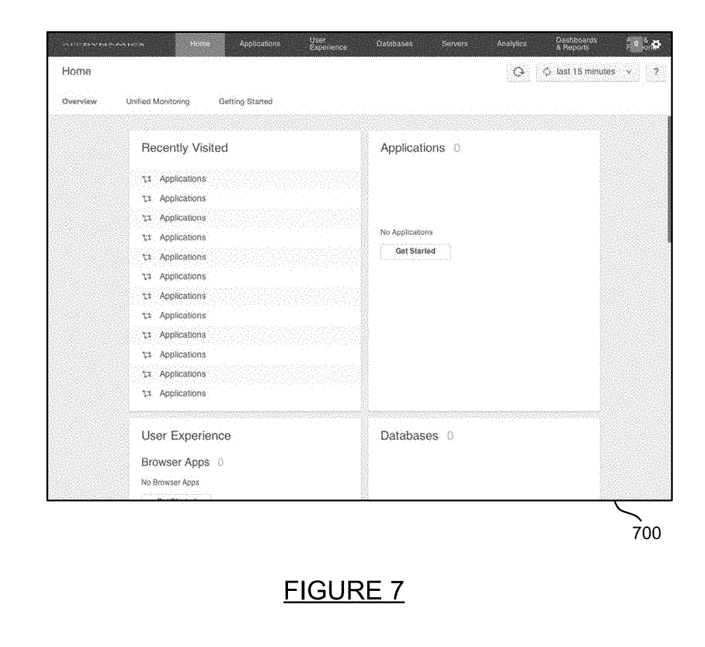

The captured content of the page is stored as a document without any unrequested content that may be associated with the URL. For example, an original URL may provide an interface as shown in FIG. 7. Interface 700 includes content portions associated with recently visited applications, applications, user experiences, and database information. The interface also includes a header showing tabs of home, applications, user experience and other content, and a second row of tabs associated with an overview, unified monitoring, and getting started.

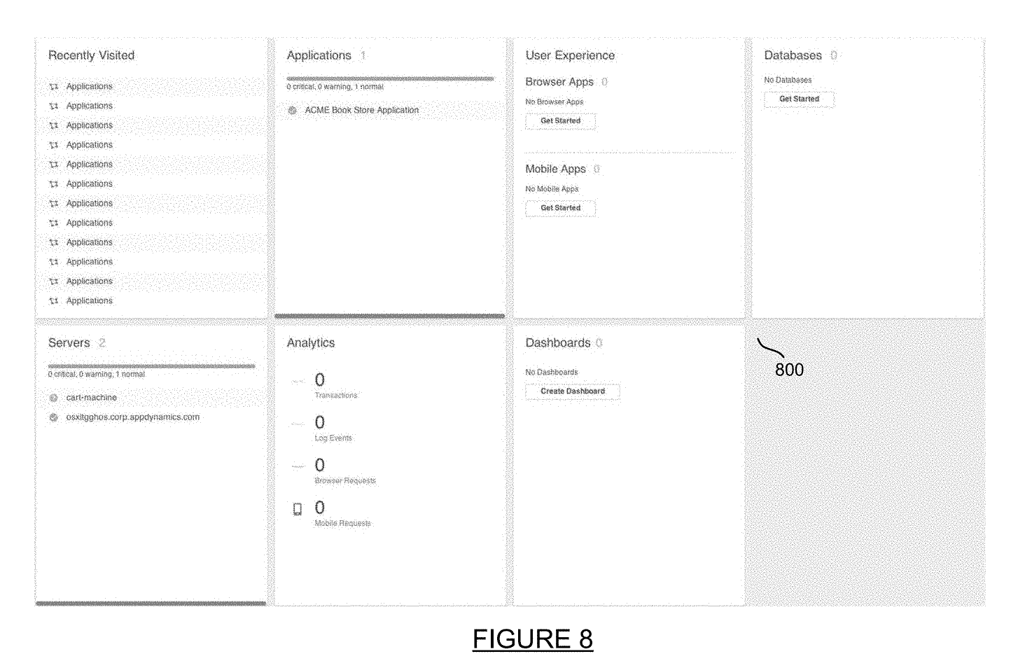

Only subset of the information provided in the interface may actually be selected for captured by a requester. FIG. 8 illustrates an example of content actually captured from the interface at a schedule point in time. As shown in FIG. 8, the captured content includes information for recently visited applications, applications, user experience information, database information, and other selected content. In particular, the header of tabs in interface 700 was not captured and therefore is not provided to a recipient within the documents created for the recipient based on the reconstructed URL.

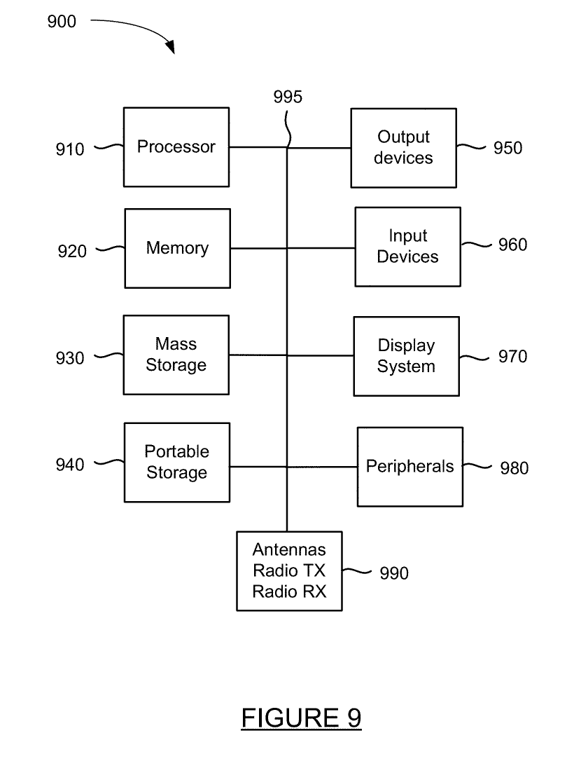

FIG. 9 is a block diagram of an exemplary system for implementing the present technology. System 900 of FIG. 9 may be implemented in the contexts of the likes of client computers 105, 192, mobile device 115, servers 125, 130, 140, 150, 160, machine 170, data stores 180 and 190, and controller 190. The computing system 900 of FIG. 9 includes one or more processors 910 and memory 920. Main memory 920 stores, in part, instructions and data for execution by processor 910. Main memory 920 can store the executable code when in operation. The system 900 of FIG. 9 further includes a mass storage device 930, portable storage medium drive(s) 940, output devices 950, user input devices 960, a graphics display 970, and peripheral devices 980.

The components shown in FIG. 9 are depicted as being connected via a single bus 990. However, the components may be connected through one or more data transport means. For example, processor unit 910 and main memory 920 may be connected via a local microprocessor bus, and the mass storage device 930, peripheral device(s) 980, portable storage device 940, and display system 970 may be connected via one or more input/output (I/O) buses.

Mass storage device 930, which may be implemented with a magnetic disk drive, an optical disk drive, a flash drive, or other device, is a non-volatile storage device for storing data and instructions for use by processor unit 910. Mass storage device 930 can store the system software for implementing embodiments of the present invention for purposes of loading that software into main memory 920.

Portable storage device 940 operates in conjunction with a portable non-volatile storage medium, such as a floppy disk, compact disk or Digital video disc, USB drive, memory card or stick, or other portable or removable memory, to input and output data and code to and from the computer system 900 of FIG. 9. The system software for implementing embodiments of the present invention may be stored on such a portable medium and input to the computer system 900 via the portable storage device 940.

Input devices 960 provide a portion of a user interface. Input devices 960 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 900 as shown in FIG. 9 includes output devices 950. Examples of suitable output devices include speakers, printers, network interfaces, and monitors.

Display system 970 may include a liquid crystal display (LCD) or other suitable display device. Display system 970 receives textual and graphical information, and processes the information for output to the display device. Display system 970 may also receive input as a touch-screen.

Peripherals 980 may include any type of computer support device to add additional functionality to the computer system. For example, peripheral device(s) 980 may include a modem or a router, printer, and other device.

The system of 900 may also include, in some implementations, antennas, radio transmitters and radio receivers 990. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 900 of FIG. 9 are those typically found in computer systems that may be suitable for use with embodiments of the present invention and are intended to represent a broad category of such computer components that are well known in the art. Thus, the computer system 900 of FIG. 9 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for securely scheduling capture of interface data, comprising:
receiving, by a server, a request to capture interface data at a schedule for an identified access level;
at a time specified within the schedule, accessing interface data by the server;
populating, by the server, a document with the accessed interface data; and
providing, by the server, the populated document with the accessed interface data along with an access token generated based on the identified access level.

2. The method of claim 1, wherein the request includes an address of the interface which includes the interface data.

3. The method of claim 1, wherein the request includes a URL for the interface.

4. The method of claim 1, wherein the request includes identification of the requested interface content and scheduling information that are stored by the server.

5. The method of claim 1, wherein the request includes access information for the requested interface content.

6. The method of claim 1, wherein the populated document is provided to a recipient via an email attachment.

7. The method of claim 1, wherein the access token is a single use token.

8. A non-transitory computer readable storage medium having embodied thereon a program, the program being executable by a processor to perform a method for securely scheduling capture of interface data, the method comprising:
receiving, by a server, a request to capture interface data at a schedule for an identified access level;
at a time specified within the schedule, accessing interface data by the server;
populating, by the server, a document with the accessed interface data; and
providing, by the server, the populated document with the accessed interface data along with an access token generated based on the identified access level.

9. The non-transitory computer readable storage medium of claim 8, wherein the request includes an address of the interface which includes the interface data.

10. The non-transitory computer readable storage medium of claim 8, wherein the request includes a URL for the interface.

11. The non-transitory computer readable storage medium of claim 8, wherein the request includes identification of the requested interface content and scheduling information that are stored by the server.

12. The non-transitory computer readable storage medium of claim 8, wherein the request includes access information for the requested interface content.

13. The non-transitory computer readable storage medium of claim 8, wherein the populated document is provided to a recipient via an email attachment.

14. The non-transitory computer readable storage medium of claim 8, wherein the access token is a single use token.

15. A system for generating cluster data for tier of servers, the system comprising:
a server including a processor and memory,
one or more modules stored in memory and executable by the processor to receive a request to capture interface data at a schedule for an identified access level, at a time specified within the schedule, access interface data, populate a document with the accessed interface data, provide the populated document with the accessed interface data along with an access token generated based on the identified access level.

16. The system of claim 15, wherein the request includes an address of the interface which includes the interface data.

17. The system of claim 15, wherein the request includes a URL for the interface.

18. The system of claim 15, wherein the request includes identification of the requested interface content and scheduling information that are stored by the server.

19. The system of claim 15, wherein the request includes access information for the requested interface content.

20. The system of claim 15, wherein the populated document is provided to a recipient via an email attachment.

21. The system of claim 15, wherein the access token is a single use token.
